(19) United States
(12) Patent Application Publication
(10) Pub. No.: US 2008/0227408 A1
(43) Pub. Date: Sep. 18, 2008

(54) APPARATUS AND METHOD FOR SWITCHING FREQUENCY BAND OF ANTENNA

(75) Inventors: Chih-Ren Hsiao, Taipei (TW); Po-Yuan Liao, Taipei (TW); Tsung-Wen Chiu, Taipei (TW); Fu-Ren Hsiao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANCED CONNECTEK INC., Taipei (TW)

(21) Appl. No.: 12/049,378

(22) Filed: Mar. 17, 2008

(30) Foreign Application Priority Data
Mar. 16, 2007 (TW) 96109116

(51) Int. Cl. H04B 1/40

(52) U.S. Cl. 455/77

(57) ABSTRACT

An apparatus and a method for switching a frequency band of an antenna, used in an electronic device having an antenna are provided. The apparatus comprises a driving device, a switching device, and a radio frequency module. The switching device is used for adjusting the frequency band of the antenna to cover a system frequency band of a communication system adopted by the electronic device. The driving device is used for receiving a switching command from the electronic device and driving the switching device accordingly, in which the switching command indicates the communication system adopted by the electronic device. The radio frequency module is used for performing down frequency conversion on the signals output by the switching device and performing up frequency conversion on the signals to be input to the switching device. Accordingly, more than two frequency bands can be supported by the electronic device with a single antenna.

### CROSS-REFERENCE TO RELATED APPLICATION

This application claims the priority benefit of Taiwan application serial no. 96109116, filed on Mar. 16, 2007. The entirety the above-mentioned patent application is hereby incorporated by reference herein and made a part of specification.

### BACKGROUND OF THE INVENTION

1. Field of the Invention

The present invention generally relates to an apparatus and a method for switching a frequency band of an antenna, and in particular, to an apparatus and a method applicable to switching a frequency band of an antenna so as to increase the range of the frequency band supported by a wireless communication system.

2. Description of Related Art

FIG. 1a is a block diagram illustrating a conventional wireless communication system. Referring to FIG. 1a, the wireless communication system includes an antenna 11, a radio frequency module 12, and a system circuit module 13. The antenna 11 is, for example, an antenna used in a general wireless communication apparatus and used for receiving and transmitting signals. When receiving a signal, the antenna 11 sends the signal to the radio frequency (RF) module 12. Then, the radio frequency module 12 performs a down frequency conversion on the signal and sends the converted signal to the system circuit module 13. On the other hand, the system circuit module 13 sends a signal to the radio frequency module 12, which then performs an up frequency conversion on the signal and sends the converted signal to the antenna 11. Finally, the signal is sent out by the antenna 11.

Conventional reduced antennas usually adopt inverted-F design. For example, Taiwanese Utility Model Patent Application No. 093203785 discloses an inverted-F antenna applied to a handheld wireless communication product. FIG. 1b is a cross-sectional diagram of the inverted-F antenna. Referring to FIG. 1b, the baseboard 14 of the antenna is 30 mm in length and 10 mm in width and is divided into a first conductor 15 and a second conductor 16 by a T-shaped groove 19, in which the first conductor 15 is 41 mm in length, 0.5 mm in width, and a current path thereof is 15a and the second conductor 16 is 7.5 mm in length, 0.5 mm in width and a current path thereof is 16a. Moreover, a feed part 17 and a short part 18 are disposed in an edge of the baseboard 14. The T-shaped groove 19 forms a zigzag current path such that the efficiency of the antenna for transmitting signals is increased and the size of the antenna is reduced.

FIG. 1c illustrates a return loss graph of the aforesaid inverted-F antenna. Referring to FIG. 1c, the central frequency W11 of the antenna operated in a resonance mode is around 890 MHz and the frequency width of the antenna is about 34 MHz under 5 dB return loss definition. Accordingly, the operating frequency width of the antenna is too narrow to cover a frequency width of about 80 MHz required by the system frequency band (880˜960 MHz) of a GSM system.

Since the volume of the antenna is reduced, the frequency width designed for a general antenna cannot cover all of the frequency widths within the frequency band of a communication system. Further, in practice, the frequency band is divided into multiple communication channels, each of which has a 0.2 MHz frequency width, so as to be used by multiple users. Accordingly, the frequency width that can be operated by an electronic device is of a single communication channel. However, if no communication channel is available during a busy period, it will sequentially result in a significant problem that the communication device cannot work.

### SUMMARY OF THE INVENTION

Accordingly, the present invention is directed to an apparatus for switching a frequency band of an antenna, in which a switching device and a driving device are used for adjusting the frequency band of the antenna according to the requirement of a communication system, such that a plurality of frequency bands can be selected so as to increase the range of the frequency band that can be applied by the antenna.

The present invention is directed to a method for switching a frequency band of an antenna. The frequency band operated by the antenna is adjusted according to the communication system or the communication channel selected by an electronic device and a data signal is transceived under the adjusted frequency band, such that various communication systems or communication channels can be supported by a single antenna.

To achieve the aforesaid purposes, the present invention provides an apparatus for switching a frequency band of an antenna, which is suitable for being disposed in an electronic device. The apparatus comprises a driving device, a switching device, and a radio frequency module. The switching device is used for adjusting the frequency band of the antenna to cover a system frequency band of a communication system adopted by the electronic device. The driving device is used for receiving a switching command from the electronic device and driving the switching device accordingly, in which the switching command indicates the communication system adopted by the electronic device. The radio frequency module is used for performing down frequency conversion on the signals output by the switching device and performing up frequency conversion on the signals to be input to the switching device.

In an embodiment of the present invention, the apparatus further comprises a system circuit module, which is used for selecting the communication system to be used by the electronic device and sending the switching command corresponding to the communication system to the driving device.

In an embodiment of the present invention, the aforesaid communication system comprises mobile communication (GSM) 850, GSM 900, GSM 1800, personal communication service (PCS) 1900, personal handy system (PHS), wideband code division multiple access (WCDMA), Bluetooth, wireless local area network (WLAN), worldwide interoperability for microwave access (WiMax), global positioning system (GPS), digital TV (DTV), or ultra-wideband (UWB) system.

In an embodiment of the present invention, the system circuit module selects the communication system according to a selecting signal sent from an operating interface or an input device of the electronic device.

In an embodiment of the present invention, the switching device comprises a switch circuit or a voltage controlled capacitor. Further, the switch circuit comprises a plurality of matching circuits, each of which corresponds to one of a plurality of frequency bands.

In an embodiment of the present invention, the antenna, the switching device, the driving device, and the radio frequency module are all integrated into one.

In an embodiment of the present invention, the communication system comprises a mobile phone, a notebook, or a digital TV.

The present invention provides a method for switching a frequency band of an antenna, suitable for an electronic device. The method comprises the following steps. First, the electronic device selects a communication system to be used for communication and sends a switching command indicating the selected communication system to a driving device. Then, the driving device drives a switching device for adjusting the frequency band of the antenna to cover a system frequency band of the communication system selected by the electronic device.

In an embodiment of the present invention, the communication system further sends a data signal to a radio frequency module, which performs up frequency conversion on the data signal. Then, the switching device transfers the data signal to the antenna corresponding to the frequency band of the antenna adjusted thereby and finally the antenna sends out the data signal converted by the radio frequency module.

In an embodiment of the present invention, the electronic device further sends a data signal to a radio frequency module and the radio frequency module performs up frequency conversion on the data signal. Then, the switching device transfers the converted data signal to the antenna corresponding to the frequency band of the antenna adjusted thereby and finally the antenna sends out the data signal.

In an embodiment of the present invention, the antenna further receives a data signal by using the frequency band adjusted by the switching device and transfers the data signal to the radio frequency module through the switching device. Then, the radio frequency module performs down frequency conversion on the data signal and sends the converted data signal to the electronic device.

In an embodiment of the present invention, the step of selecting the communication system to be used for communication and sending the switching command indicating the selected communication system to the driving device comprises using a system circuit module to select the communication system to be used by the electronic device and sends the switching command corresponding to the communication system to the driving device.

In an embodiment of the present invention, the aforesaid communication system comprises GSM 850, GSM 900, GSM 1800, PCS 1900, PHS, WCDMA, Bluetooth, WLAN, WiMax, GPS, DTV, and UWB system.

The antenna, switching device, driving device, radio frequency module, and system circuit module included in the apparatus for switching the frequency band of the antenna are all able to be integrated into a main body through an integrated circuit process, so as to form a single antenna system without increasing the volume of the antenna. The present invention adjusts a frequency width of an antenna to be corresponding to one of a plurality of communication systems or communication channels, such that when various users use different communication systems or different communication channels to communicate, the antenna can be switched to a corresponding frequency band to cover the one required by the communication system or communication channel, such that the applicable frequency band of the antenna can be effectively increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1a is a block diagram illustrating a conventional wireless communication system.

FIG. 1b is a cross-sectional view of a conventional inverted-F antenna.

FIG. 1c is a return loss graph of the inverted-F antenna.

FIG. 2a is a block diagram illustrating an apparatus for switching a frequency band of an antenna according to an embodiment of the present invention.

FIG. 2b is a return loss graph of an antenna according to an embodiment of the present invention.

FIG. 2c is a schematic diagram illustrating a switch circuit according to an embodiment of the present invention.

FIG. 2d is a schematic diagram illustrating a voltage controlled capacitor according to an embodiment of the present invention.

FIG. 3 is a flowchart of a method for switching a frequency band of an antenna according to an embodiment of the present invention.

FIG. 4 is a flowchart of a method for switching a frequency band of an antenna according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

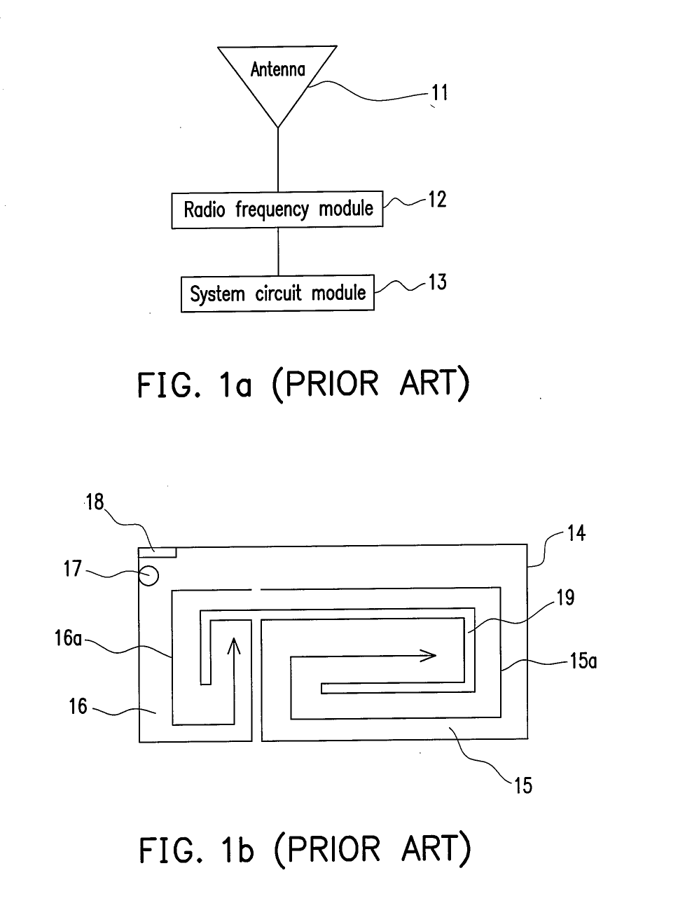

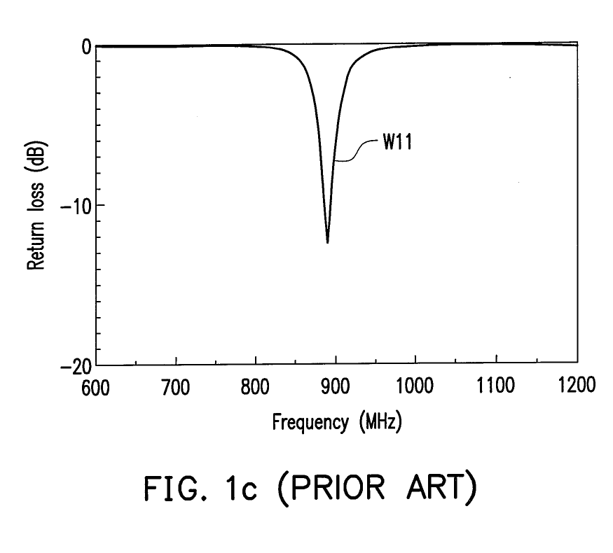

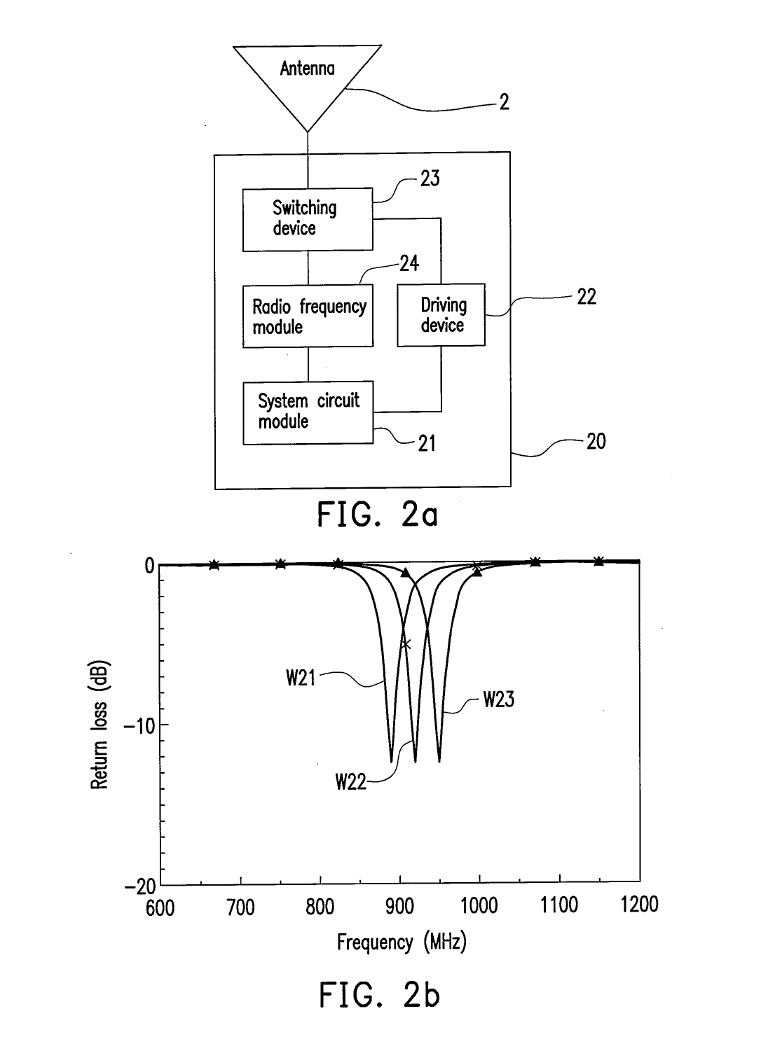

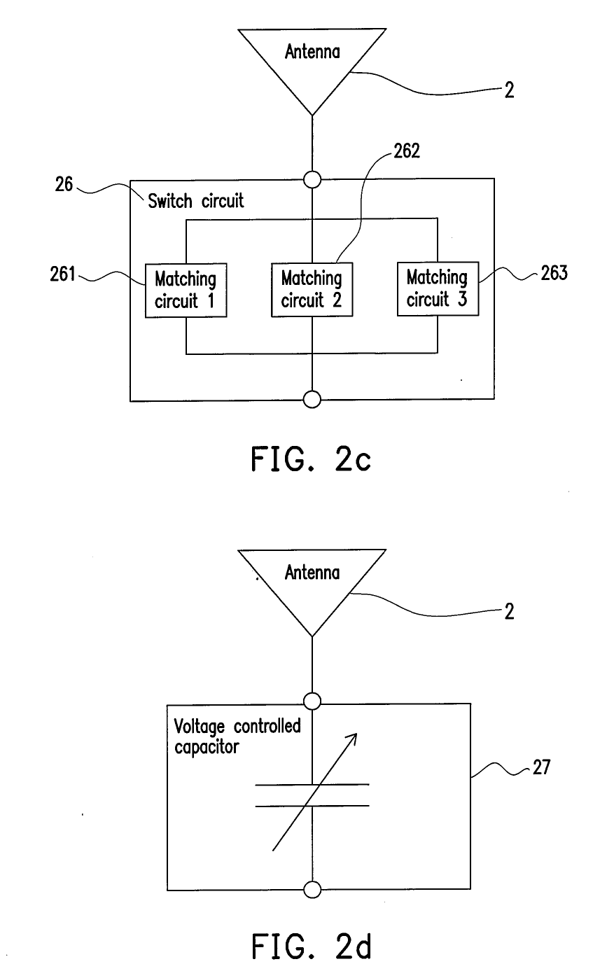

FIG. 2a is a block diagram illustrating an apparatus for switching a frequency band of an antenna according to an embodiment of the present invention. Referring to FIG. 2a, the apparatus 20 is disposed in an electronic device such as a mobile phone, a notebook, or a digital TV, and primarily includes a system circuit module 21, a switching device 22, a driving device 23, and a radio frequency module 24. The apparatus 20 is coupled to an antenna 2 for switching the frequency band thereof, where the antenna 2 is an antenna adopted by a general wireless communication device for receiving and transmitting signals, and the structure thereof is similar to that of the conventional antenna as shown in FIG. 1b so that the related description is omitted herein. The functions of the aforesaid elements of the apparatus 20 are described as follows.

The system circuit module 21 is used for selecting the communication system to be used by the electronic device and sends a switching command corresponding to the selected communication system to the driving device 23. The communication system may be GSM 850 (824˜894 MHz), GSM 900 (880˜960 MHz), GSM 1800 (1710˜1880 MHz), PCS 1900 (1850˜1990 MHz), PHS (1880˜1990 MHz), WCDMA (1920˜2170 MHz), Bluetooth (2400˜2484 MHz), WLAN (2400˜2500 MHz), WiMax (2˜6 GHz), GPS (1575 MHz), DTV (174˜226 MHz), or UWB system (3.1˜10.6 GHz), but not limited to them.

The system circuit module 21 may select the communication system according to a selecting signal sent from an operating interface or an input device of the electronic device. That means a user may select the communication system through the operating interface displayed on the screen of the electronic device or the input device disposed on the electronic device, and then the electronic device automatically adjusts the frequency band of the antenna 2 so as to support the communication. For example, for a dual band phone, a user may choose GSM or PHS to make a phone call. If the GSM is selected, the system circuit module 21 sends the switching command corresponding to GSM so as to adjust the frequency band of the antenna 2.

FIG. 2b is a return loss graph of an antenna according to an embodiment of the present invention. Referring to FIG. 2b, the original central frequency W21 of the resonance mode of the antenna 2 is 890 MHz, and the frequency width thereof is about 34 MHz (873˜907 MHz) under 5 dB return loss definition. The central frequency W21 of the resonance mode of the antenna 2 is switched to 920 MHz and 950 MHz by the switching device 23 which is driven by the driving device 22. The return loss curves respectively represent the switched central frequencies W22 and W23 and the frequency widths thereof are 36 MHz (903˜939 MHz) and 34 MHz (934˜968 MHz) respectively. Accordingly, the antenna 2 of the present embodiment can effectively increase the usable range of the frequency band up to 95 MHz (873˜968 MHz), which indicates the apparatus 20 can greatly increase the usable frequency width of the antenna 2.

It should be noted herein that the system circuit module 21 may be used for selecting one of a plurality of communication channels in a communication system and sends the switching command accordingly. In detail, when a plurality of communication devices are communicated through the same communication system, the system circuit module 21 may divide the system frequency band of the communication system into a plurality of communication channels, each of which occupies a corresponding frequency band. Accordingly, the communication devices may share the system frequency band of the communication system so as to communicate synchronously.

The driving device 22 is used for receiving the switching command sent by the system circuit module 21 and drives the switching device 23 accordingly. The switching device 23 is then used for adjusting the frequency band of the antenna 2 to cover a system frequency band of a communication system adopted by the electronic device. The switching device 23 may be implemented by a switch circuit or a voltage controlled capacitor, and the corresponding embodiments are given below.

FIG. 2c is a schematic diagram illustrating a switch circuit according to an embodiment of the present invention. The switch circuit 26 may include at least two matching circuits therein, but not limited to this number. For example, a matching circuit 261, a matching circuit 262, and a matching circuit 263 are disposed in the switch circuit 26 and each of which corresponds to a frequency band of a communication system or a communication channel. When a communication system or a communication channel is selected, the driving device drives the switch circuit to switch between the matching circuits, so as to adjust the matching resistance of the antenna 2 to a corresponding frequency band. As the number of matching circuits increase, the number or the range of the frequency band that can be covered by the antenna 2 is expanded, and therefore the number of the communication systems that can be supported by the electronic device is increased.

FIG. 2d is a schematic diagram illustrating a voltage controlled capacitor according to an embodiment of the present invention. The voltage controlled capacitor 27 disposes a capacitor component therein and uses various voltage levels to change the capacitance of the capacitor component, so as to adjust the matching resistance of the antenna 2. Therefore, the frequency band of the antenna 2 can be adjusted to any specific range and the number of the communication systems or communication channels supported by the electronic device is increased.

As the frequency band of the antenna is set by the switching device and the driving device, the rest modulation and signal decoding procedures are performed by the system circuit module 21 and radio frequency module 24, in which the radio frequency module 24 is used for performing down frequency conversion on the signals output by the switching device and performs up frequency conversion on the signals to be input to the switching device.

It should be noted herein that the foregoing antenna 2, switching device 23, driving device 22, and radio frequency module 24 can be integrated into one to form the apparatus for switching the frequency band of the antenna 2 without increasing the volume of the whole antenna 2. The apparatus 20 for switching the frequency band of the antenna 2 can be applied to wireless communication products such as mobile phones and notebooks, or can be used for switching channels of digital TVs.

According to the foregoing apparatus, the present invention also provides a method for switching the frequency band of the antenna so as to send or receive a data signal. Embodiments are given below for describing detail steps of the method.

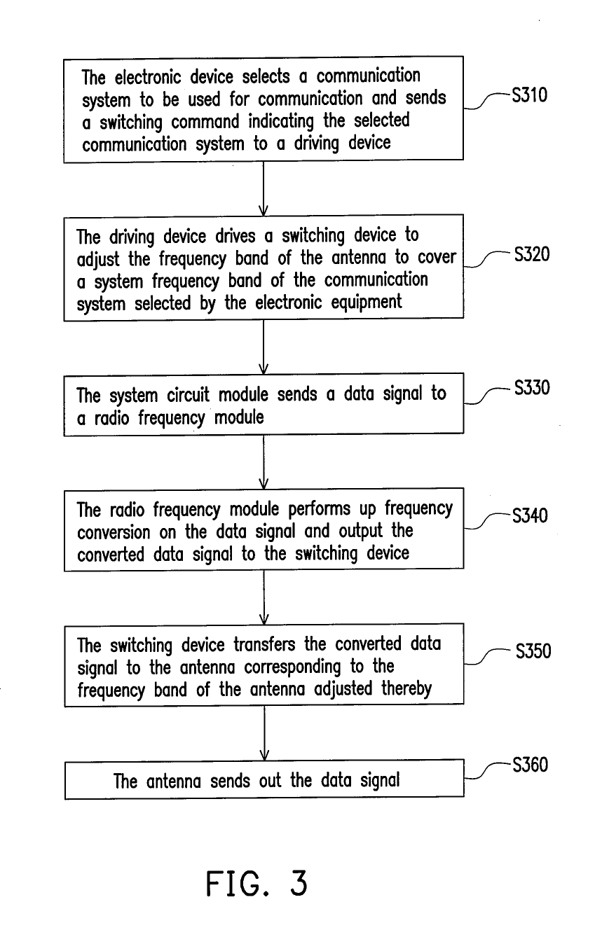

FIG. 3 is a flowchart of a method for switching a frequency band of an antenna according to an embodiment of the present invention. Referring to FIG. 3, the present embodiment is suitable for an electronic device having the apparatus for switching the frequency band of the antenna as described in the former embodiment to transmit a data signal. The electronic device can be a mobile phone, a notebook, or a digital TV, but not limited to them.

First, the electronic device selects a communication system to be used for communication and sends a switching command indicating the selected communication system to a driving device (S310). The communication system is selected by a system circuit module of the electronic device according to a selecting signal sent from an operating interface or an input device of the electronic device.

When the driving device receives the switching command, it drives the switching device accordingly such that the switching device adjusts the frequency band of the antenna to cover a system frequency band of the communication system selected by the electronic device (S320). The switching device is, for example, a switch circuit having a plurality of matching circuits or a voltage controlled capacitor. The driving device may choose one of the matching circuits in the switch circuit to process the signal transferred thereby so as to transmit the signal through the frequency band that corresponds to the selected communication system. On the other hand, the driving device may adjust the voltage level supplied to the voltage controlled capacitor so as to transmit the signal through the specified frequency band.

When the frequency band of the antenna is set by the switching device, the system circuit module may send a data signal to a radio frequency module (S330), and then the radio frequency module performs up frequency conversion on the data signal and outputs the converted data signal to the switching device (S340).

The switching device transfers the data signal to the antenna corresponding to the frequency band of the antenna adjusted by itself (S350) and finally the antenna sends out the data signal (S360). According to the foregoing method, the electronic device may select the communication system for communication by simply sending a switching command to change the frequency band of the antenna before sending the data signal. Therefore, a plurality of communication systems can be supported and an overall frequency band applicable for the electronic device to send the data signal is expanded.

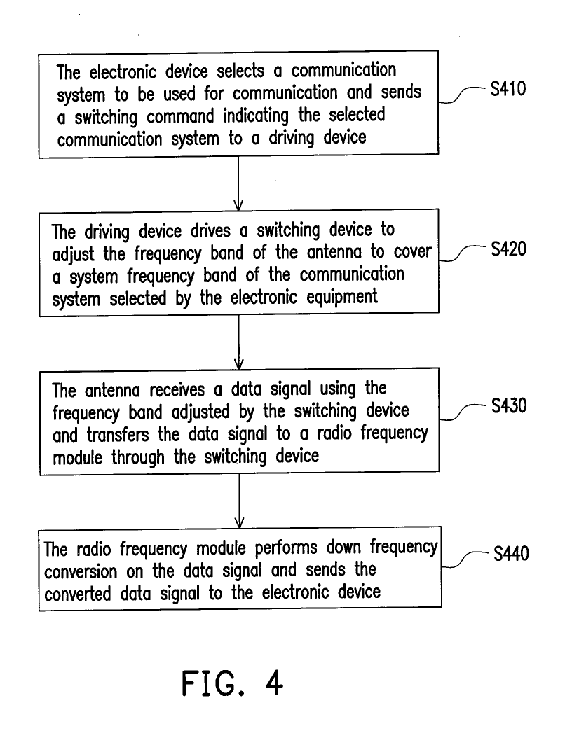

FIG. 4 is a flowchart of a method for switching a frequency band of an antenna according to an embodiment of the present invention. Referring to FIG. 4, the present embodiment is suitable for an electronic device having the apparatus for switching the frequency band of the antenna as described in the former embodiment to receive a data signal. The electronic device can be a mobile phone, a notebook, or a digital TV, but not limited to them.

First, the electronic device selects a communication system to be used for communication and sends a switching command indicating the selected communication system to a driving device (S410). The communication system is selected by a system circuit module of the electronic device according to a selecting signal sent from an operating interface or an input device of the electronic device.

When the driving device receives the switching command, it drives the switching device accordingly such that the switching device adjusts the frequency band of the antenna to cover a system frequency band of the communication system selected by the electronic device (S420). The foregoing steps S410 and S420 are similar to the steps S310 and S320 as described in the former embodiment, such that the related description is not repeated herein.

When the frequency band of the antenna is set by the switching device, the antenna may receive a data signal using the frequency band adjusted by the switching device and transfers the data signal to a radio frequency module through the switching device (S430). In detail, the switching device may be a switch circuit having a plurality of matching circuits or a voltage controlled capacitor. The data signal received by the antenna may be transferred to the radio frequency module through a corresponding matching circuit or the voltage controlled capacitor set by the driving device.

Finally, the radio frequency module performs down frequency conversion on the data signal and sends the converted data signal to the electronic device (S440). According to the foregoing method, the electronic device may select the communication system for communication and receive the data signal accordingly. Therefore, a plurality of communication systems can be supported and an overall frequency band applicable for the electronic device to receive the data signal is expanded.

To sum up, an operating interface or an input device of the electronic device may be used for manually selecting communication systems or communication channels for communication and producing the switching command accordingly. Then, the electronic device automatically switches the frequency band of the antenna so as to support the communication. Therefore, the efficiency for switching the frequency band of the antenna is enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for switching a frequency band of an antenna, suitable for being disposed in an electronic device, the apparatus comprising:
a switching device for adjusting the frequency band of the antenna to cover a system frequency band of a communication system adopted by the electronic device;
a driving device for receiving a switching command from the electronic device and driving the switching device accordingly, wherein the switching command indicates the communication system adopted by the electronic device; and
a radio frequency module for performing down frequency conversion on the signals output by the switching device and performing up frequency conversion on the signals to be input to the switching device.

2. The apparatus for switching a frequency band of an antenna according to claim 1, further comprising:
a system circuit module for selecting the communication system to be used by the electronic device and sending the switching command corresponding to the communication system to the driving device.

3. The apparatus for switching a frequency band of an antenna according to claim 2, wherein the communication system is selected from a group consisted of mobile communication (GSM) 850, GSM 900, GSM 1800, personal communication service (PCS) 1900, personal handy system (PHS), wideband code division multiple access (WCDMA), Bluetooth, wireless local area network (WLAN), worldwide interoperability for microwave access (WiMax), global positioning system (GPS), digital TV (DTV), and ultra-wideband (UWB) system.

4. The apparatus for switching a frequency band of an antenna according to claim 2, wherein the system circuit module selects the communication system according to a selecting signal sent from an operating interface or an input device of the electronic device.

5. The apparatus for switching a frequency band of an antenna according to claim 1, wherein the switching device comprises a switch circuit or a voltage controlled capacitor.

6. The apparatus for switching a frequency band of an antenna according to claim 1, wherein the switch circuit comprises a plurality of matching circuits, each of which is corresponding to one of a plurality of frequency bands.

7. The apparatus for switching a frequency band of an antenna according to claim 1, wherein the antenna, the switching device, the driving device, and the radio frequency module are all integrated into one.

8. The apparatus for switching a frequency band of an antenna according to claim 1, wherein the electronic device is selected from a group consisted of a mobile phone, a notebook, and a digital TV.

9. A method for switching a frequency band of an antenna, suitable for an electronic device, the method comprising the following steps:
the electronic device selecting a communication system to be used for communication and sending a switching command indicating the selected communication system to a driving device; and
the driving device driving a switching device for adjusting the frequency band of the antenna to cover a system frequency band of the communication system selected by the electronic device.

10. The method for switching a frequency band of an antenna according to claim 9, further comprising the following steps:
the electronic device sending a data signal to a radio frequency module;
the radio frequency module performing up frequency conversion on the data signal;
the switching device transferring the data signal to the antenna corresponding to the frequency band of the antenna adjusted thereby; and
the antenna sending out the data signal.

11. The method for switching a frequency band of an antenna according to claim 9, further comprising the following steps:
the antenna receiving a data signal by using the frequency band adjusted by the switching device and transferring the data signal to the radio frequency module through the switching device; and
the radio frequency module performing down frequency conversion on the data signal and sending the converted data signal to the electronic device.

12. The method for switching a frequency band of an antenna according to claim 9, wherein the step of selecting the communication system to be used for communication and sending the switching command indicating the selected communication system to the driving device comprises:
using a system circuit module to select the communication system to be used by the electronic device and send the switching command corresponding to the communication system to the driving device.

13. The method for switching a frequency band of an antenna according to claim 12, wherein the communication system is selected from a group consisted of GSM 850, GSM 900, GSM 1800, PCS 1900, PHS, WCDMA, Bluetooth, WLAN, WiMax, GPS, DTV, and UWB system.

14. The method for switching a frequency band of an antenna according to claim 9, wherein the electronic device is selected from a group consisted of a mobile phone, a notebook, and a digital TV.
